(19) United States
(12) Patent Application Publication
(10) Pub. No.: US 2022/0016905 A1
(43) Pub. Date: Jan. 20, 2022

(54) SYSTEMS AND METHODS OF PRINTING ON FLEXIBLE MATERIALS

(71) Applicant: NIKE, Inc., Beaverton, OR (US)

(72) Inventors: Todd W. Miller, Portland, OR (US); Eli R. Troyke, Portland, OR (US)

(73) Assignee: NIKE, Inc., Beaverton, OR (US)

(21) Appl. No.: 17/298,518

(22) PCT Filed: Nov. 27, 2019
(86) PCT No.: PCT/US2019/063738

§ 371 Date: May 28, 2021

Related U.S. Application Data
(60) Provisional application No. 62/773,994, filed on Nov. 30, 2018.

(51) Int. Cl. B41J 3/54; B41J 3/407; B41J 11/00; B41J 25/00; B41J 25/308

(52) U.S. Cl. CPC B41J 3/543; B41J 3/4078; B41J 11/0055; B41J 11/007; B41J 2203/011; B41J 11/00214; B41J 25/001; B41J 25/308; B41J 11/0085

(57) ABSTRACT

This disclosure relates generally to manufacturing systems and, more particularly, to systems and methods for printing on flexible materials. Various novel systems and methods of using the same are provided, including printing systems, roll dispensing system, and other processing systems.

### FIELD

This disclosure relates generally to manufacturing systems, including systems and methods for printing on materials.

### BACKGROUND

The manufacturing of materials for use in various consumer products, such as apparel, can be labor intensive and time consuming For example, methods and systems for printing on flexible materials, as well as the methods and systems of conveying such materials to print systems, are often inefficient.

### BRIEF DESCRIPTION OF THE DRAWINGS

FIG. 1 illustrates an exemplary embodiment of a manufacturing system that includes a roll dispensing station, print station, and cutting station.

FIG. 2 illustrates an exemplary embodiment of a roll dispensing station.

FIG. 3 illustrates another exemplary embodiment of a roll dispensing station.

FIGS. 4A-4C illustrate an exemplary roll dispensing apparatus and method of use.

FIGS. 5A-5D illustrate an exemplary roll dispensing apparatus and method of use.

FIGS. 6A-6G illustrate an exemplary system and method for coupling a trailing end portion of a first roll to a leading end portion of a second roll.

FIG. 7 illustrates an exemplary print station for dispensing print materials onto a substrate.

FIG. 8 illustrates an exemplary print station with side guide members.

FIG. 9 illustrates another embodiment of an exemplary print station with guide members.

FIG. 10 illustrates an exemplary embodiment of a headbox with a plurality of print assemblies.

FIGS. 11A-11F illustrate an exemplary system and method for dispensing print materials using the headbox of FIG. 10.

FIGS. 12A-12F illustrate an exemplary structure formed by dispensing print materials using the headbox of FIG. 10.

FIG. 13 illustrates an exemplary headbox with a plurality of print assemblies and curing assemblies.

FIG. 14 illustrates an exemplary headbox with a plurality of print assemblies and curing assemblies.

FIG. 15 illustrates an exemplary print station for dispensing print materials on a substrate.

FIG. 16 illustrates an exemplary substrate with print materials thereon.

FIG. 17 illustrates another exemplary substrate with print materials thereon.

FIG. 18 illustrates an exemplary cutting station for cutting a substrate with printed materials thereon.

FIG. 19 illustrates an exemplary embodiment of a print station and computing system.

### DETAILED DESCRIPTION

General Considerations

The systems and methods described herein, and individual components thereof, should not be construed as being limited to the particular uses or systems described herein in any way. Instead, this disclosure is directed toward all novel and non-obvious features and aspects of the various disclosed embodiments, alone and in various combinations and subcombinations with one another. For example, any features or aspects of the disclosed embodiments can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

As used herein, the term “exemplary” means serving as a non-limiting example, instance, or illustration. As used herein, the terms “e.g.,” and “for example,” introduce a list of one or more non-limiting embodiments, examples, instances, and/or illustrations.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

As used herein, “downstream” refers to a direction defined by the path of travel of a substrate or other material during a manufacturing process, such as the path of travel of a substrate on a moving conveyor belt. As used herein, “upstream” refers to a direction that is opposite the downstream direction. As used herein, “lateral” refers to a direction that is at a right angle to the downstream and upstream directions (e.g., across a conveyor belt).

As used herein, the term “flexible material” refers to any material that can be dispensed from a roll. Examples of flexible materials include textile, natural fabric, synthetic fabric, knit, woven material, nonwoven material, mesh, leather, synthetic leather, polymer, rubber, and foam, or any combination of thereof.

The systems and methods disclosed herein are described, in some embodiments, in connection with the manufacture of apparel products using flexible materials. The manufacture of apparel products is an exemplary application of the systems and method described herein. It should be understood that the systems and methods described herein can be used in other applications. For example, the systems and methods disclosed herein that involve rolled materials can be used in other industries in which rolled materials are processed. Similarly, the printing systems disclosed herein, such as a headbox with multiple print and/or curing assemblies, can be used in any process in which a material, whether flexible or not, receives a print material while it is conveyed along a surface.

As used herein, the term “article of apparel” refers to any apparel or clothing, including any article of footwear, as well as hats, caps, shirts, jerseys, jackets, socks, shorts, pants, undergarments, athletic support garments, gloves, wrist/arm bands, sleeves, headbands, and the like, which can be manufactured, in whole or in part, from a flexible material.

Exemplary System Overview

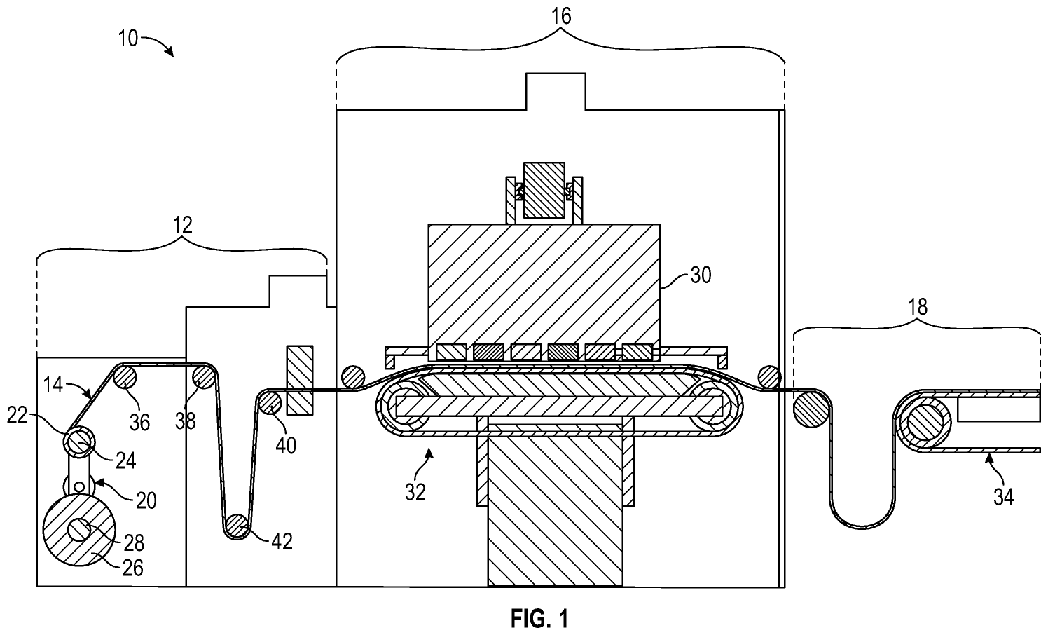

FIG. 1 depicts an exemplary system 10 that includes a roll station 12 that receives one or more rolls of a substrate 14. The substrate 14 is then conveyed to one or more stations for further processing. In the illustrated embodiment of FIG. 1, the substrate is conveyed from the roll station 12 to a print station 16, and then from print station 16 to a cutting station 18.

As shown in FIG. 1, in some embodiments, roll station 12 can include a dispensing apparatus 20 that receives a first roll 22 on a first spindle 24 and receives a second roll 26 on a second spindle 28. As discussed in more detail below, roll station 12 can be configured to facilitate the coupling of a portion of a depleting roll to a portion of a replacement roll to improve operational efficiencies by, for example, reducing an amount of stoppage time that may be otherwise be required when changing rolls.

In the illustrated embodiment, print station 16 includes a headbox 30 positioned above a first conveyor system 32. As used herein, “headbox” refers to a structure that includes a plurality of print assemblies. Headbox 30 is moveable laterally above first conveyor system 32 so that it can print materials onto the substrate 14 as the substrate 14 is conveyed by first conveyor system 32. A cutting station 18 can be positioned downstream of print station 16. The processed substrate can be cut and/or have portions removed at the cutting station.

The roll station, print station, cutting stations, and components thereof are described in detail below. As indicated above, it should be understood that each of these systems and the components thereof can be used alone or in various combinations with other systems and components thereof. Thus, the different stations and/or their components described herein can be used together (e.g., as shown in FIG. 1), individually, or in some other combination. For example, the disclosed print stations and/or components thereof can be used without the disclosed roll stations and/or components thereof, and vice versa.

Exemplary Roll Dispensing Systems and Methods

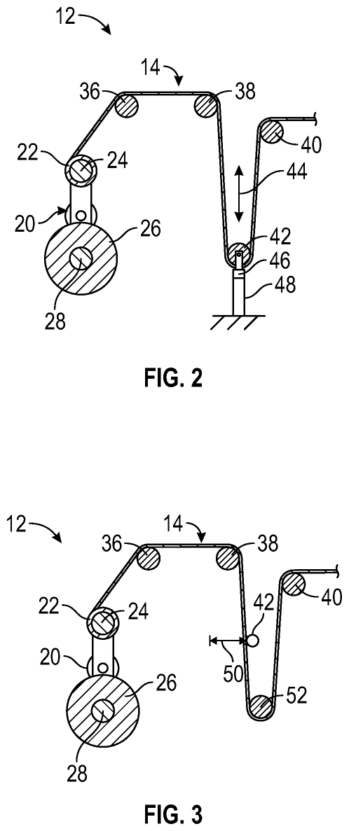

FIG. 2 is an exemplary embodiment of roll station 12 and dispensing apparatus 20, which includes first spindle 24 and second spindle 28. One or more fixed rollers, such as first guide roller 36, second guide roller 38, and third guide roller 40, can be provided to guide the substrate 14 from dispensing apparatus 20 to print station 16. It should be understood that the number and arrangement of guide rollers can vary, as would be understood by one of ordinary skill in the art having the benefit of this disclosure. The guide rollers can be mounted to any fixed member, such as a frame or other supporting structure.

In some embodiments, one or more moveable rollers, such as tensioning roller 42, can be provided to adjust a tension of the substrate 14 along a dispensing path of the substrate 14. Tensioning roller 42 can be coupled to an actuating member that causes tensioning roller 42 to move in two directions, such as up and down as shown by arrow 44, to adjust an amount of tension in the substrate 14 in the vicinity of tensioning roller 42. For example, in the illustrated embodiment, the actuating member is a linear actuator 46 coupled to a vertical rail 48 along which the tensioning roller 42 can move. If linear actuator 46 causes tensioning roller 42 to move downward, tension is increased in the substrate 14 in the vicinity of tensioning roller 42. If linear actuator 46 causes tensioning roller 42 to move upward, tension is decreased in the substrate 14 in the vicinity of tensioning roller 42. Thus, tensioning roller 42 can control the amount of tension in the substrate 14 to prevent or reduce the occurrence of undue tension or overrun.

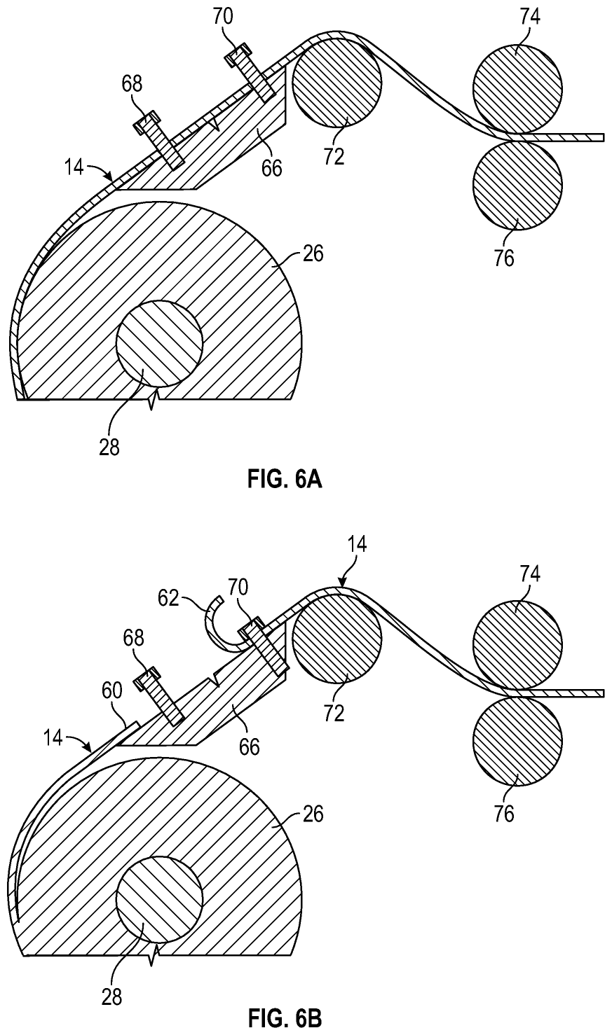

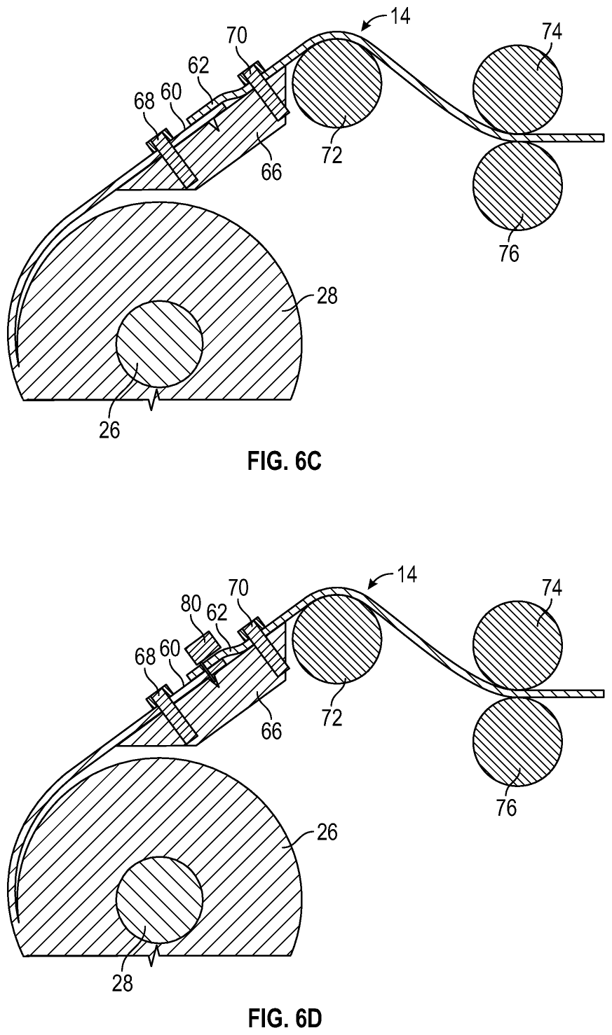

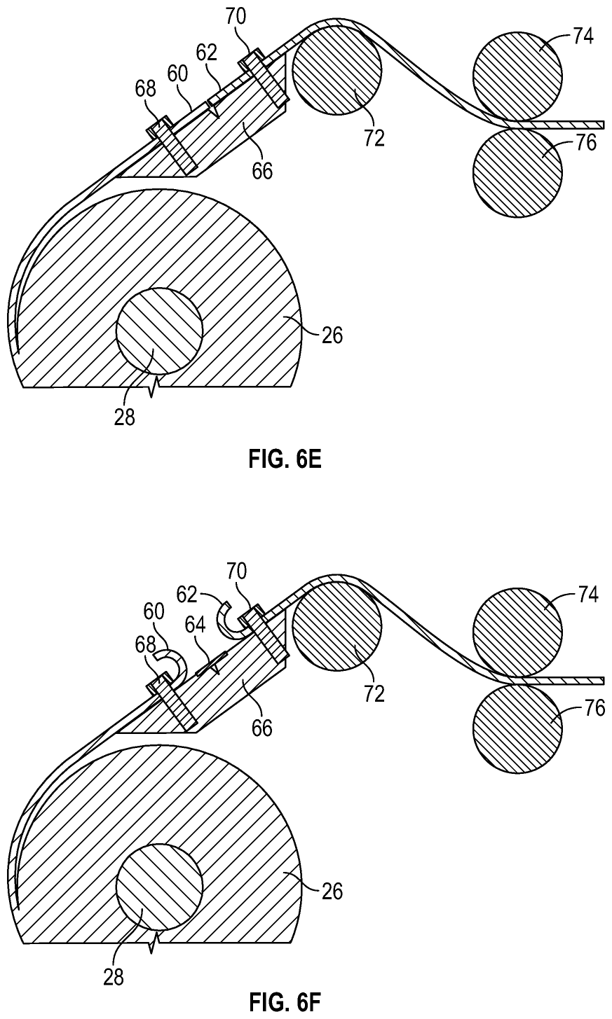

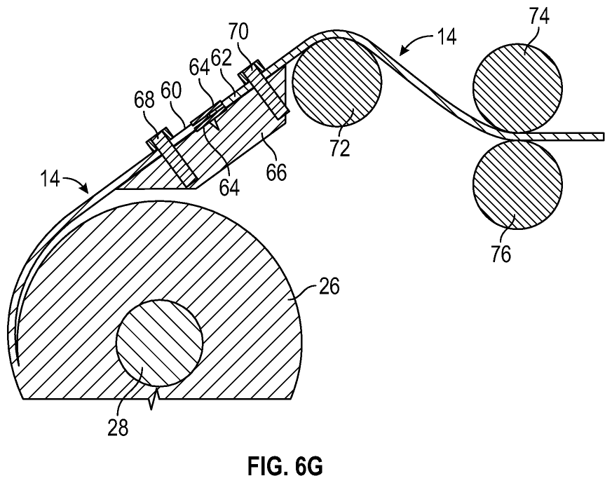

In some embodiments, it may be desirable to intentionally introduce additional slack in the substrate 14 between dispensing apparatus 20 and print station 16. In particular, the creation of additional slack in the dispensing path of the substrate 14 can permit dispensing apparatus 20 to stop dispensing substrate 14 without affecting the delivery of substrate 14 to processing stations downstream of dispensing apparatus 20 (e.g., print station 16 and/or cutting station 18). Thus, as described in more detail below with respect to FIGS. 6A-6G, by introducing sufficient slack in the substrate 14 downstream from dispensing apparatus 20, dispensing apparatus 20 can stop dispensing substrate 14 and a trailing portion of the currently dispensing roll (e.g., first roll 22) can be coupled to a leading portion in a replacement roll (e.g., second roll 26), allowing for a change in the dispensing roll without impacting the operation of a downstream process.

In the embodiment shown in FIG. 2, slack can be introduced by first increasing tension in the substrate 14 by moving tensioning roller 42 downward and then decreasing the tension in the material by moving tensioning roller 42 upward. This increases the length of material that is available between tensioning roller 42 and print station 16. The creation of slack in this manner allows the system to stop dispensing material upstream from tensioning roller 42 and perform (via an operator or automated process) a coupling operation between the currently dispensing roll and a replacement roll.

Although tensioning roller 42 is illustrated in FIG. 2 as moving up and down, tensioning roller 42 can be positioned and operated in any manner that is sufficient to create the desired slack in the substrate 14. For example, FIG. 3 illustrates an alternative arrangement of tensioning roller 42 in which it is movable horizontally, as shown by arrow 50. The position of tensioning roller 42 can be adjusted by, for example, a rail and actuating member system that is configured to achieve horizontal movement of tensioning roller 42. In this example, roller 52 can be another tensioning roller (moveable, for example, up and down like tensioning roller 42) or another fixed roller.

In addition to the vertical and horizontal movement of the tensioning roller(s) shown in FIGS. 2 and 3, tensioning roller(s) can alternatively be arranged to move in any direction between vertical and horizontal, as well as along various paths (e.g., straight, curved, or otherwise), so long as that movement is sufficient to introduce an amount of slack desired to achieve the coupling operation of the dispensing and replacement rolls.

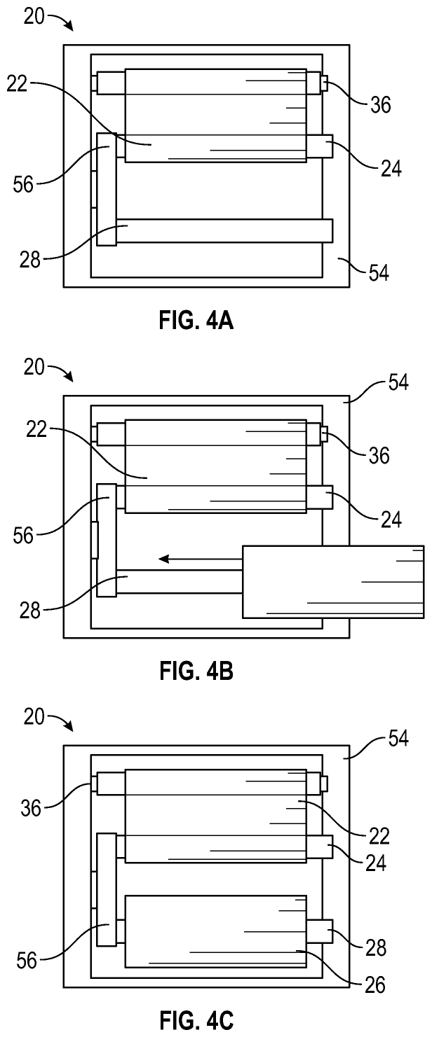

FIGS. 4A-4C illustrate an exemplary method for loading a replacement roll (e.g., second roll 26) onto dispensing apparatus 20. In FIG. 4A, first roll 22 is received on first spindle 24 and second spindle 28 is empty. Dispensing apparatus 20 includes a frame 54 that supports a rotatable member (e.g., spindle-supporting arm 56) that connects first and second spindles 24, 28. As shown in FIG. 4B, second spindle 28 can be loaded with a replacement roll (e.g., second roll 26) while the first roll 22 continues to dispense substrate 14. The second roll can be loaded onto second spindle 28 in any manner, such as by pivoting second spindle 28 to the side so that the second spindle is free and unsupported at one end, thereby allowing the second roll 26 to be moved onto the free end. Once loaded, the free end of second spindle 28 can pivot back to its original position with the second roll 26 secured thereon.

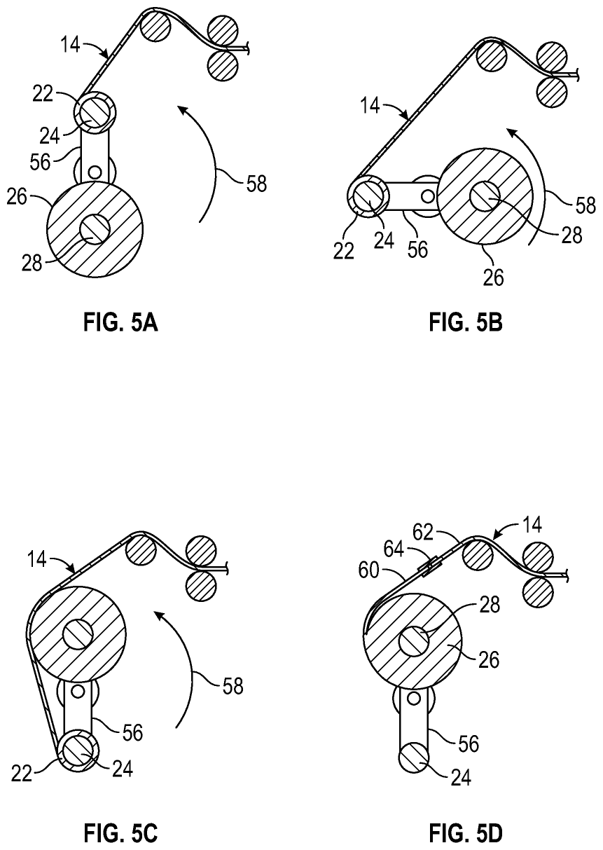

FIGS. 5A-5D illustrate an exemplary method of operating dispensing apparatus 20 to cause a replacement roll to move into position for coupling with a dispensing roll. As shown in FIGS. 5A-D5, the dispensing roll (e.g., first roll 22) can be replaced by the replacement roll (e.g., second roll 26) by rotating spindle-supporting arm 56 in the direction shown by arrow 58 so that the second roll 26 is moved into the dispensing position that was previously maintained by the first roll 22. As this rotation is happening, the first roll 22 can continue to dispense material as shown in FIGS. 5A-5C. Alternatively, the dispensing of the first roll 22 can be stopped before rotating the second roll into position. However, if the first roll 22 has stopped dispensing, the coupling operation may have to occur more quickly and/or a greater amount of slack may be required since the amount of slack in the material will begin to decrease after the first roll 22 stops dispensing.

FIG. 5A shows dispensing apparatus 20 with the first roll 22 dispensing substrate 14 from first spindle 24 and the second roll 26 loaded onto second spindle 28. FIG. 5B shows the first roll 22 continuing to dispense the substrate 14 as spindle-supporting arm 56 begins to rotate in the direction of arrow 58 (i.e., counterclockwise) to move the second roll 26 into position for dispensing substrate 14. FIG. 5C illustrates dispensing apparatus 20 after the rotation has been completed and the second roll 26 is in position for coupling a leading edge portion with a trailing edge portion of the first roll 22. FIG. 5D illustrates the result of a coupling operation in which a leading edge portion 60 of the second roll 26 has been coupled to a trailing edge portion 62 of the first roll 22 with a connecting member 64. Connecting member 64 can be, for example, a low-profile material or device (e.g., with a thickness of less than 1 cm), such as one or more pieces of tape that extend between and secure together the leading edge portion 60 of the second roll 26 and the trailing edge portion 62 of the first roll 22.

FIGS. 6A-6G illustrate an exemplary method for securing the leading edge portion 60 of the second roll 26 to the trailing edge portion 62 of the first roll 22. FIG. 6A shows the substrate 14 being dispensed from the first roll 22 after the first roll 22 has been moved into the lower position (as shown, for example, in FIG. 5C). A platform 66 can be provided for supporting one or both of the leading edge portion 60 of the second roll 26 and the trailing edge portion 62 of the first roll 22 during a coupling operation. Platform 66 can be supported by frame 54 or, alternatively, another adjacent fixed structure. One or more guide rollers, such as guide rollers 72, 74, 76, can be positioned downstream of platform 66 to guide the movement of the substrate 14 as desired.

Platform 66 can have one or more securing members for holding the leading edge portion 60 and/or the trailing edge portion 62, such as first clamping member 68 and second clamping member 70. As shown, in FIGS. 6A-6G, first and second clamping members 68, 70 can move between disengaged positions and engaged positions. In the disengaged position, the substrate can move freely relative to the platform and in the engaged position the substrate is secured in place so that it does not move relative to platform 66. Clamping members therefore operate by applying pressure to at least a portion of the surface of the substrate to hold it in place. First and second clamping members 68, 70 can move between the disengaged and engaged positions, and vice versa, independently of each other.

FIG. 6A shows both first and second clamping members 68, 70 in the disengaged position, which allows the substrate 14 to move freely across platform 66. In FIG. 6B, second clamping member 70 has moved into the engaged position to secure the trailing edge portion 62 of the first roll 22 to platform 66. Prior to securing the trailing edge portion 62 in this manner, a sufficient amount of slack can be introduced along the dispensing path (e.g., between the dispensing apparatus and the print station) to allow for sufficient time to perform the coupling operation. That is, an amount of slack created by tensioning roller 42 is preferably sufficient to permit continuous operation of the system while the trailing edge portion 62 is fixed in position by second clamping member 70. As used in the context of the movement of the substrate and related operations, “continuous” and “continuous operation” refers to preventing undesirable interruptions of a process/operation. It does not, however, require that the substrate be continually moving since, during normal operation of the system, movement of the substrate may start and stop as it is being processed (e.g., during certain cleaning, printing, or cutting processing).

The amount of slack desired will depend on the amount of time required to perform the coupling operation and the speed at which the material is being conveyed to print station 16. For example, if the coupling operation requires one minute, then a sufficient amount of slack can be created to allow for the continuous feed of substrate 14 to print station 16 during the one minute coupling operation. Depending on the speed of which the substrate is moving, the amount of slack created (i.e., the amount that the dispensing path is increased) can be, for example, one foot, two feet, or between two and ten feet, such as between two and six feet.

Referring again to FIG. 6B, first clamping member 68 is shown in the disengaged position so that the leading edge portion 60 of the second roll 26 can be moved into position for coupling with the trailing edge portion 62. After the leading edge portion 60 is moved onto the platform, first clamping member 68 can move into the engaged position to secure the leading edge portion 60 to platform 66 as shown in FIG. 6C.

To reduce the resulting thickness of the substrate at the point of coupling, rather than securing the leading edge portion 60 to trailing edge portion 62 in an overlapping manner, an end of the leading edge portion 60 can be positioned adjacent to an end of the trailing edge portion 62 without the two ends overlapping, as shown in FIG. 6E.

In one embodiment, alignment of the ends of the first and second rolls can be achieved by initially overlapping the ends and then cutting the ends while in the overlapping orientation. For example, as shown in FIG. 6C, an end of the leading edge portion 60 can be positioned so that it overlaps with an end of the trailing edge portion 62. Then, with both first and second clamping members 68, 70 engaged, a cut 78 can be performed at an overlapping area of the leading edge portion 60 and trailing edge portion 62 as shown in FIG. 6D. The cut 78 can be performed in various manners, such as by a sharp cutting edge, laser, and/or a hot edge. In FIG. 6D, the cut 78 is performed by a slide cutter 80 with a sharp cutting edge that is moveable across the width of the substrate 14 in a guided manner

As shown in FIG. 6E, after the cut 78 is made, excess material can be removed resulting in the end of the leading edge portion 60 being adjacent to and aligned with the end of the trailing edge portion 62. FIGS. 6F and 6G illustrate a method of coupling these two adjacent edges with a connecting member 64. Connecting member 64 can be an adhesive tape can adhere to the substrate that is being dispensed. The connecting member 64 can be positioned on one or both sides of the adjacent edges to secure the two edge portions 60, 62 together. For example, FIG. 6F illustrates a first connecting member 64 (e.g., tape) being positioned on platform 66 for receiving adjacent lower surfaces of the respective edge portions 60, 62 and FIG. 6G illustrates a second connecting member 64 (e.g., tape) positioned on adjacent upper surfaces of the respective edge portions 60, 62.

Exemplary Printing Systems and Methods

Referring again to FIG. 1, a substrate can be conveyed from roll station 12 to a print station 16. As discussed above, the print stations disclosed herein can be used with roll station 12 or, alternatively, with other roll dispensing systems that are suitable for conveying substrates to print station 16.

The embodiments disclosed herein include systems and methods for printing and curing print materials onto a substrate 14. Print station 16 can utilize various types of printing techniques. These can include, but are not limited to, liquid inkjet printing, solid ink printing, dye-sublimation printing, as well as any other methods of printing. In some cases, print station 16 can use a combination of two or more different printing techniques within the same operation. For example, coloring inks can be printed by one print assembly, while clear or opaque print materials are printed by another print assembly to form structural layers.

Generally, the print stations described herein can apply any kind of print material to the substrate. As used herein, “print material” refers to any material that can be printed, ejected, emitted, or otherwise deposited during an additive manufacturing process. Exemplary print materials include inks as well as resins, plastics, or other print materials associated with 2D and/or 3D printing. In some embodiments, the materials used in the printing technology could be any aqueous ink, dye-based ink, pigment-based ink, solvent-based ink, dye-sublimation ink, thermoplastics e.g., PLA and ABS) and thermoplastic powders, acrylic resin, polyurethane, thermoplastic polyurethane, silicone, or any other curable substance. Still further examples of materials include high-density polyurethylene, eutectic metals, rubber, modeling clay, plasticine, RTV silicone, porcelain, metal clay, ceramic materials, plaster, and photopolymers, as well as other materials known for use in 3D printing.

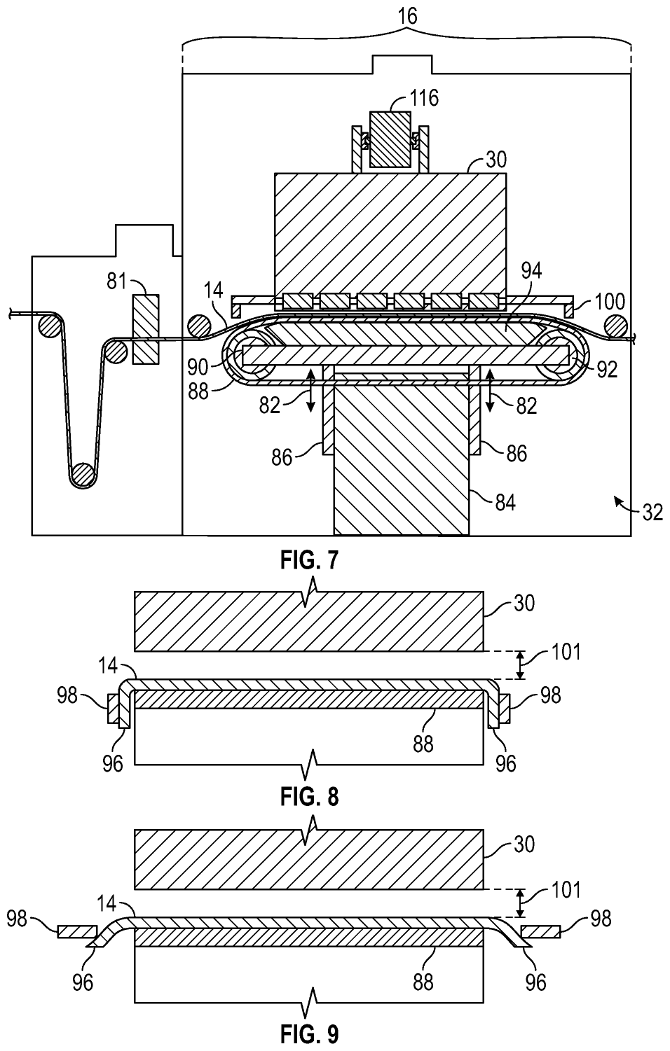

FIG. 7 illustrates print station 16 in more detail. In addition, FIG. 7 illustrates an inline, processing station 81 that can treat the substrate 14 before printing. The processing station 81 can be, for example, a plasma cleaning station. Plasma cleaning as a pre-treatment for printing can improve the ability of a variety of materials, such as textiles and polymers, by improving the wettability of the material to improve bonding of printed materials to the substrate 14. The plasma cleaning station can be an open-air plasma station or it can be performed in a closed system that is suitably vented.

As shown in FIG. 7, the plasma station is preferably positioned adjacent the print station 16 to reduce an amount of time between performing the plasma cleaning and printing on the material. By positioning the plasma station immediately adjacent to the print station 16, better adhesion of print materials to the substrate can be obtained. In some embodiments, the exit point of the plasma station is within five feet from an initial print area of print station 16, in others, the plasma station is between one to five feet, one to four feet, one to three feet, or between one to two feet.

Print station 16 comprises a headbox 30 with a plurality of print assemblies for printing materials onto the substrate 14 as it moves along a first conveyor system 32. The distance between the substrate 14 and print assemblies and any associated curing assemblies is desirably accurately set and maintained to improve the resulting printed product. Accordingly, one or both of headbox 30 and first conveyor system 32 can be moveable up and down to adjust a relative distance between the print assemblies and a surface of the substrate 14 moving along the first conveyor system 32. This also allows the system to adjust to accommodate materials with different thicknesses, as well as to adjust to accommodate different print/curing operations that require variations in spacing from the surface of material that is being processed at print station 16.

In the embodiment shown in FIG. 7, first conveyor system 32 can be configured to move up and down (in the direction of arrows 82) with headbox 30 being fixed in height. For example, the first conveyor system 32 can be mounted on a frame 84 that comprises a plurality of position control members 86, such as linear actuators. In FIG. 7, two position control members 86 are shown. In some embodiments, there can be three or four position control members spaced apart from one another around the frame to permit greater height control, including pitch variation, between the material surface and the print/curing assemblies.

The first conveyor system can be any type of conveyor system. In the illustrated embodiment, the conveyor system is a vacuum conveyor system that receives the substrate 14 on a surface thereof for printing. The vacuum conveyor system can include a perforated belt 88 that extends around a drive roller 90 and an idler roller 92 to form an endless conveyor belt loop. A vacuum bed 94 applies a vacuum to belt 88, through apertures in belt 88, thereby holding the substrate 14 in place on the surface of belt 88.

Printing operations often benefit from maintaining a high degree of accuracy in spacing between a print surface and printheads. The vacuum conveyor system can facilitate maintaining this accuracy by holding the substrate 14 down on the surface of belt 88. If additional adherence is needed, the material of the perforated belt can also be selected to have a greater stickiness (i.e., increased friction between the belt surface and the conveyed substrate 14). In addition, or alternatively, one or more guide members can be provided to help further maintain a consistent height of the substrate as it is conveyed through the print station.

Rolled goods generally have salvage edges on either side of the substrate 14. Salvage edges can be provided, for example, to reduce unravelling or fraying of a material. In some cases, the salvage edge may not be suitable for printing. Salvage edges may also be thicker than the rest of the fabric. These salvage edges can be held down to prevent them from rising up and interfering with the printing process at print station 16.

If desired, the substrate 14 can be held down along a side of the first conveyor system to help maintain a consistent desired height of the substrate 14 along the first conveyor system. For example, FIG. 8 shows a cross-sectional view of the substrate 14 on belt 88 with edges 96 of the substrate 14 held down by guide members 98. In the illustrated embodiment, edges 96 of the substrate 14 extend beyond the surface of belt 88 and are held down on both sides of belt 88 by one or more guide members 98 extending along at least a portion of the length of the first conveyor system. By holding the edges 96 at the sides, a desired spacing 101 can be maintained between the surface of the substrate 14 and the print/curing assemblies. In addition, because guide members 98 are positioned lower than the highest surface of the substrate 14 when it is received on belt 88, the guide members 98 remain out of the way of headbox 30 and other print station components.

FIG. 9 illustrates an alternative arrangement of guide members 98 in which they are positioned to extend outwardly from the side. Again, as in FIG. 8, the guide members 98 of FIG. 9 are preferably positioned lower than the highest surface of the substrate 14 when it is received on belt 88.

A collision sensor 100 can be provided to further ensure the proper spacing between the print surface of the substrate 14 and the print/curing assemblies. For example, a collision sensor can be configured to detect a decrease in a desired gap or spacing between a surface of the substrate and the printheads and/or headbox, such as by detecting an increase in height of the substrate relative to the belt (e.g., with a fixed headbox height).

The collision sensor can be any sensor capable of identifying when the substrate 14 extends into an area of detection, such as by interrupting a beam of light (e.g., an optical sensor) or physically engaging with the sensor (e.g., a mechanical sensor). By identifying when the substrate, or a portion thereof, moves into a position or space that is too close to the printheads and/or lower surface of the headbox, the system can ensure that the substrate maintains a proper distance from the printheads as it moves along the first conveyor system, which can improve print consistency and image resolution.

If the substrate 14 trips the collision sensor 100 an appropriate action can be taken, such as stopping the operation of the printing process, adjusting the position of the substrate 14 on belt 88, and/or adjusting the relative spacing between the surface of the material and the print/curing assemblies (e.g., by lowering the height of the first conveyor system with the position control members 86). Preferably, the collision sensor 100 is capable of distinguishing between print material, which may pass through the area of detection by the collision sensor, and the substrate 14. In addition, as shown in FIG. 7, the substrate 14 can enter first conveyor system 32 from a position below a maximum height of belt 88. This can further reduce the likelihood that the substrate 14 will exceed a desired maximum height, which would also trigger the collision sensor 100, if provided.

The collision sensor can be positioned to detect a change in height along a width of the first conveyor system. For example, the collision sensor can monitor a height of the substrate across the width of the first conveyor system relative to a position of the headbox and/or the first conveyor system (e.g., relative to a belt height). Alternatively, the collision sensor can be positioned to monitor a height of the substrate along a longitudinal access of the first conveyor system. Multiple collision sensors can be provided, if needed, to monitor different portions of the substrate.

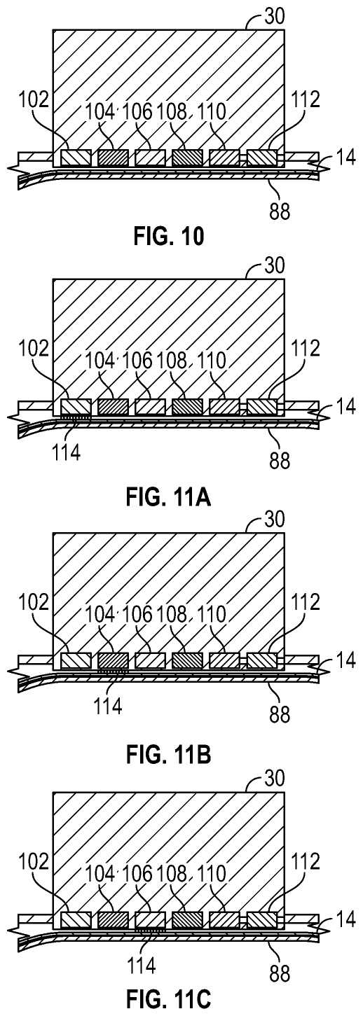

Print station 16 comprises a headbox 30 with a plurality of print assemblies for printing materials onto the substrate 14 as it conveyed along first conveyor system 32. FIG. 10 shows a plurality of print assemblies arranged sequentially in rows along a length of headbox 30 extending in the direction of first conveyor system 32 (i.e., along the longitudinal axis LA). In the embodiment shown in FIG. 10, six print assemblies are provided, including first print assembly 102, second print assembly 104, third print assembly 106, fourth print assembly 108, fifth print assembly 110, and sixth print assembly 112.

Each print assembly can include one or more printhead with one or more nozzles for dispensing droplets of a print material onto the substrate. As used herein, droplets may refer to any suitable volume of print material. For example, an ink droplet of the type discussed below may range from 2 picoliters to 80 picoliters. Other sizes are possible, depending on the application (e.g., the substrate, the print material, and the desired product).

The print assemblies and printheads associated therewith are all independently operable. Thus, as a substrate is conveyed beneath the headbox, the print assemblies and printheads can operate to dispense print materials on the substrate at the same time, but at different locations on the substrate.

As discussed in more detail below, each of the print assemblies 102, 104, 106, 108, 110, 112 can have a plurality of printheads so that, as the substrate 14 advances, multiple layers can be formed on the substrate 14 by each row of print assemblies. Thus, for example, if each of the six print assemblies 102, 104, 106, 108, 110, 112 have eight printheads, then print station 16 is capable of printing 48 layers on the material as it moves through print station 16.

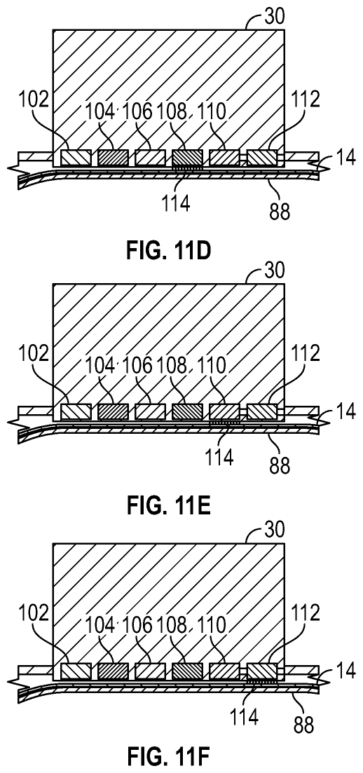

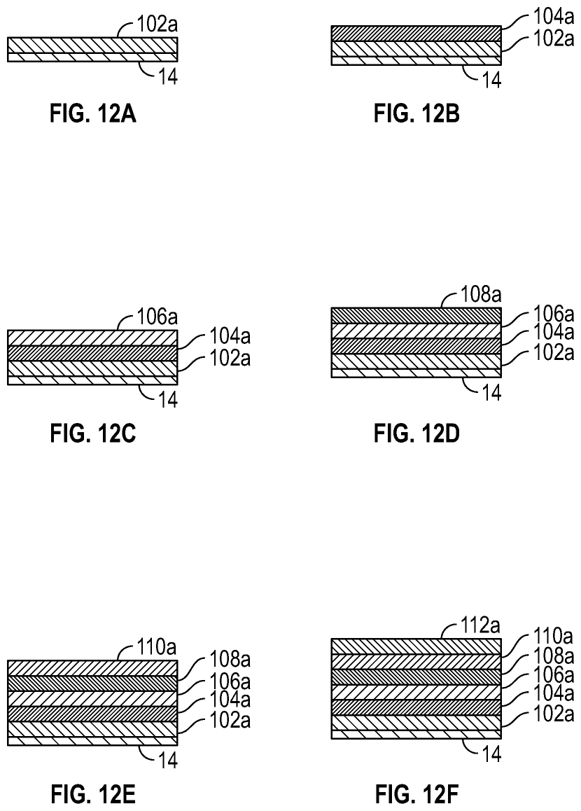

FIGS. 11A-11F illustrate each of the print assemblies 102, 104, 106, 108, 110, 112, sequentially printing layers of ink 114 onto the surface of the substrate 14. Thus, for example, FIG. 11A shows ink 114 being delivered onto the surface of the substrate 14 to form a first layer 102a, FIG. 11B shows ink 114 being delivered onto the surface of the first layer 102a to form a second layer 104a, FIG. 11C shows ink 114 being delivered onto the surface of the second layer 104a to form a third layer 106a, FIG. 11D shows ink 114 being delivered onto the surface of the third layer 106a to form a fourth layer 108a, FIG. 11E shows ink 114 being delivered onto the surface of the fourth layer 108a to form a fifth layer 110a, and FIG. 11F shows ink 114 being delivered onto the surface of the fifth layer 110a to form a sixth layer 112a. FIGS. 12A-12F, show the sequential formation of layers 102a, 104a, 106a, 108a, 110a, 112a.

In addition, it should be noted that each of these layers can themselves comprise multiple layers. For example, if there are eight printheads in print assembly 102 and all are operational in forming the first layer 102a, then the first layer 102a can comprise eight layers of ink

Referring again to FIG. 7, as the substrate 14 moves along a longitudinal axis of belt 88 and headbox 30 is moveable laterally across the length of the substrate 14 (i.e., in a direction that is perpendicular to the longitudinal axis LA of the belt). Headbox 30 can be conveyed, for example, laterally along one or more rails 116 that support the headbox in a direction perpendicular to longitudinal axis LA. An actuating device is provided to drive the headbox back and forth along the rails. The actuating device can be any known system, device, or method for moving equipment in a printing process, such as a linear actuator or other drive devices.

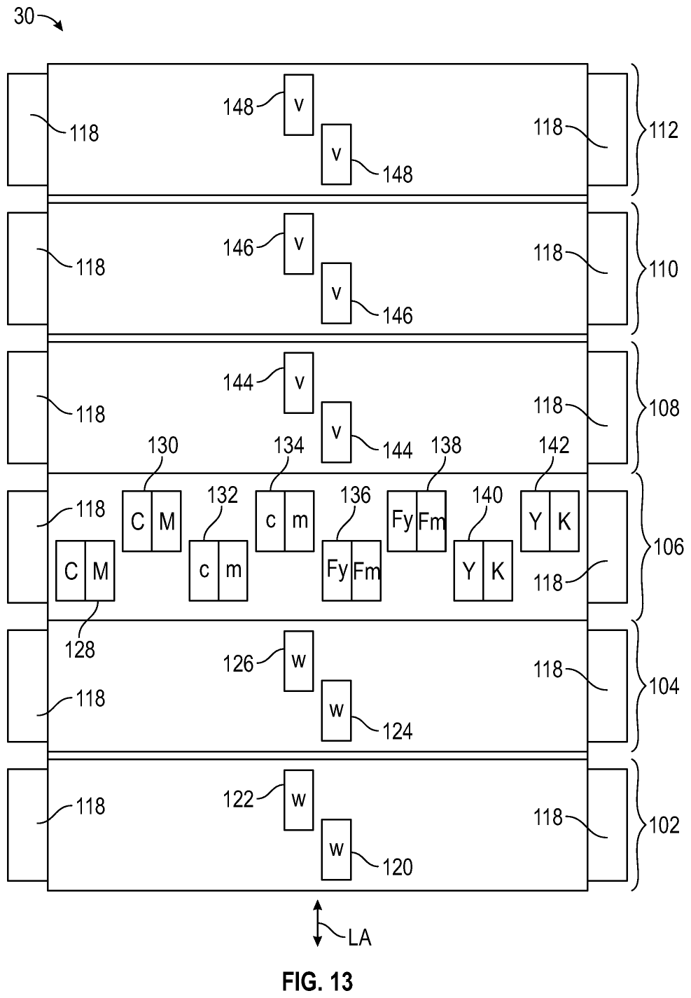

One or more curing assemblies can be provided with each print assembly, if desired. For example, FIG. 13 illustrates a pair of curing assemblies 118 on each print assembly, one on each side of the respective print assembly. By providing a curing device on opposing sides of a print assembly, a curing device will be travelling behind the print assembly regardless of the direction that the print assembly is traveling (e.g., left or right in the lateral direction). Thus, a curing step can be performed immediately after a print material is dispensed from a printhead to at least partially cure the print material Immediate curing of delivered print material may be desirable to reduce or eliminate mixing of subsequent print materials. Alternatively, if mixing is desired between layers, the curing step can be delayed or omitted. Similarly, if a particular gloss level is desired, the curing step can be delayed as needed to achieve the desired gloss level.

Since each row in headbox 30 can comprise multiple print heads, it may be desirable to provide more than one curing step within a row. That is, for example, if there are two printheads in a row, it may be desirable to dispense print materials from the first printhead, perform a first curing step, dispense print materials from the second printhead, and then perform a second curing step. The number of curing steps performed in each row can be selected, for example, based on the number of printheads, the number of layers desired, the print materials and/or an amount of mixing of print materials desired, and/or a desired gloss level.

The curing assemblies can comprise any curing assembly suitable for curing the print material associated with its respective print assembly. Exemplary lamps that could be used with the curing assemblies described herein include, but are not limited to, mercury vapor lamps (including H type, D type, or V type mercury lamps), fluorescent lamps, and/or UV LED devices. The type of lamps used may vary according to the type of print material, the type of printing application, the type of print device used, as well as other manufacturing considerations including cost and availability. In addition, just as a headbox can include different print materials in different print assemblies, the curing assemblies also can differ within the headbox. Thus, for each print assembly, an associated curing assembly can be selected based on the print materials dispensed by that print assembly (i.e., the printheads in that print assembly row).

FIG. 13 illustrates a headbox 30 with an exemplary configuration of print assemblies 102, 104, 106, 108, 110, 112. In the disclosed embodiment, printheads in a print assembly are staggered relative to other printheads in that assembly. The staggered arrangement can advantageously allow for a reduced length of each print assembly, and therefore a reduced length (i.e., in the direction of the longitudinal axis) for headbox 30.

The number of rows of print assemblies can vary. Preferably, there are at least four rows of print assemblies. In some embodiments, there can be between four and eight rows of print assemblies, or between four and six rows of print assemblies, such as six rows of print assemblies. In some embodiments, there may be more than eight rows of print assemblies, such as ten rows.

The position of the print assemblies within individual rows of headbox 30 can be fixed. Thus, as headbox 30 moves, the relative locations of the print assemblies within the headbox does not change. Alternatively, each print assembly can be mounted on one or more rails within each row so that they are moveable within headbox 30 by an associated actuating system (e.g., a linear actuator driven by an electric motor or other drive device).

The arrangement shown in FIG. 13 can vary depending on the application. For example, FIG. 13 shows an arrangement where the number of printheads in each assembly varies from two to eight. This arrangement can be modified and any print assembly can be provided with a desired number of printheads for a particular application. In addition, the type of printed material delivered by any print assembly can vary.

In the exemplary embodiment, first print assembly 102 is shown having two printheads 120, 122 that dispense white ink (w) as their print material. Thus, these two print heads can form two layers of white ink. A curing operation can take place, if desired, after dispensing one or both layers to at least partially cure the layers dispensed by print assembly 102, which collectively form first layer 102a on the substrate.

The two printheads 124, 126 of second print assembly 104 are also shown as dispensing white ink (w) as their print material. Thus, like first print assembly 102, second print assembly 104 can also form two layers of white ink, which collectively make up second layer 104a.

Third print assembly 106 illustrates a print assembly with eight different print heads for printing color inks. Printheads 128, 130, 123, 134, 140, 142 include “CMYK” pigments that are used in color printing: “C” for a cyan pigment, “M” for a magenta pigment, “Y” for a yellow pigment, and “K” for a black pigment, which may include “c” for light cyan pigment (lighter than the “C” cyan pigment) and “m” for light magenta pigment (lighter than the “M” magenta pigment). Fluorescent yellow ink (Fy) and fluorescent magenta ink (Fm) are the print materials provided in printheads 136, 138. As discussed above, depending the desired result, a curing step can be performed after dispensing print material from any of the printheads in the third print assembly or the curing step can be delayed to permit greater mixing. In particular, combinations of the dispensed color print materials can be intermixed to produce various colors and shades thereof. The CMYK and FyFm print materials can be of any type of print material, including water based, oil based, or structural print materials.

Fourth, fifth, and sixth print assemblies 108, 110, 112 are each shown with a pair of printheads 144, 146, 148 that dispense a varnish as the print material.

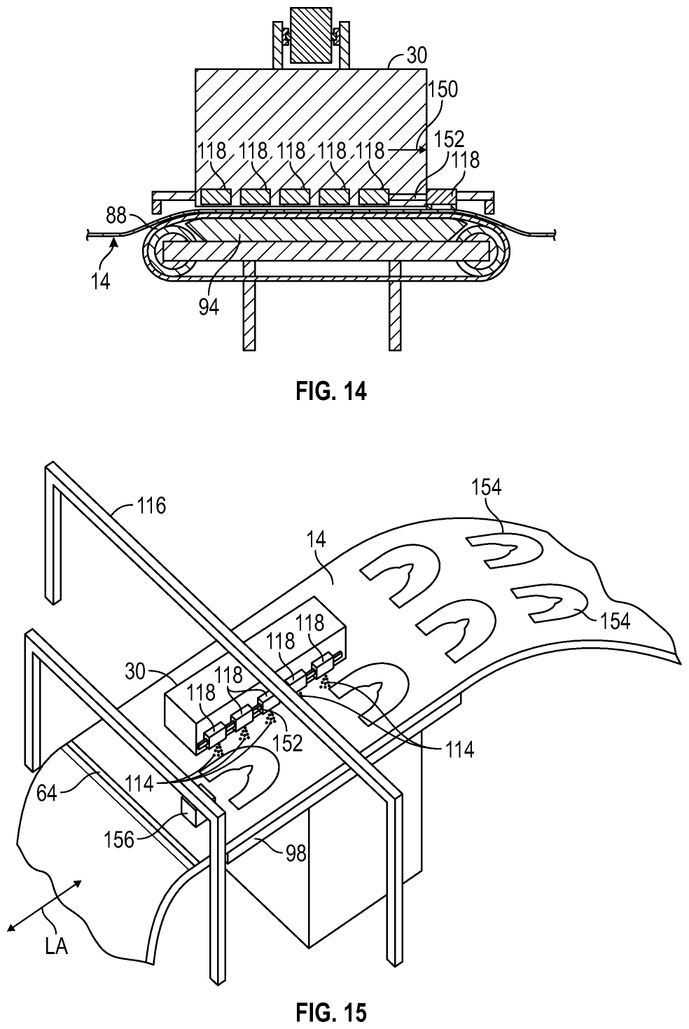

In addition, in some embodiments, the curing assemblies 118 can move in the direction of the longitudinal axis LA to adjust a longitudinal spacing with a print assembly. In this manner, greater control over the timing of a particular curing step can be achieved. For example, FIG. 14 illustrates one of the curing assemblies 118 moving in the direction of arrow 150 away from sixth print assembly 112 to delay curing after sixth print assembly 112 dispenses its print material. Movement of a curing assembly in this manner can be achieved, for example, by providing a supporting structure 152, such as a track or rail along which the curing device can move with the assistance of a linear actuator or other such drive device.

FIG. 15 is another view of print station 16 with headbox 30 comprising a plurality of print assemblies and a plurality of curing assemblies 118 that are moveable in the direction of the longitudinal axis LA. In this example, print station 16 is dispensing printed material on the substrate to form a plurality of upper patterns 154, which can be cut out from the substrate and removed to form articles of footwear.

In some embodiments, a sensor 156 can be provided at one or more locations to detect the presence and location of connecting member 64 (e.g., tape coupling a first roll to a second roll). The location of a connecting member 64 can be used to adjust a print process to reduce waste by not printing material on the connecting member 64. In addition, to the extent that print station 16 is printing a repeating pattern, the pattern can be “reset” immediately after the connecting member 64.

Sensor 156 can be any type of optoelectronic inspection sensor suitable for identifying the presence of the connecting member 64. For example, sensor 156 can comprise a light source and photoelectric sensor that responds to the intensity of light that is reflected back by a surface of the substrate 14. Alternatively, sensor 156 can be another type of sensor, such as an imaging sensor associated with a machine vision system.

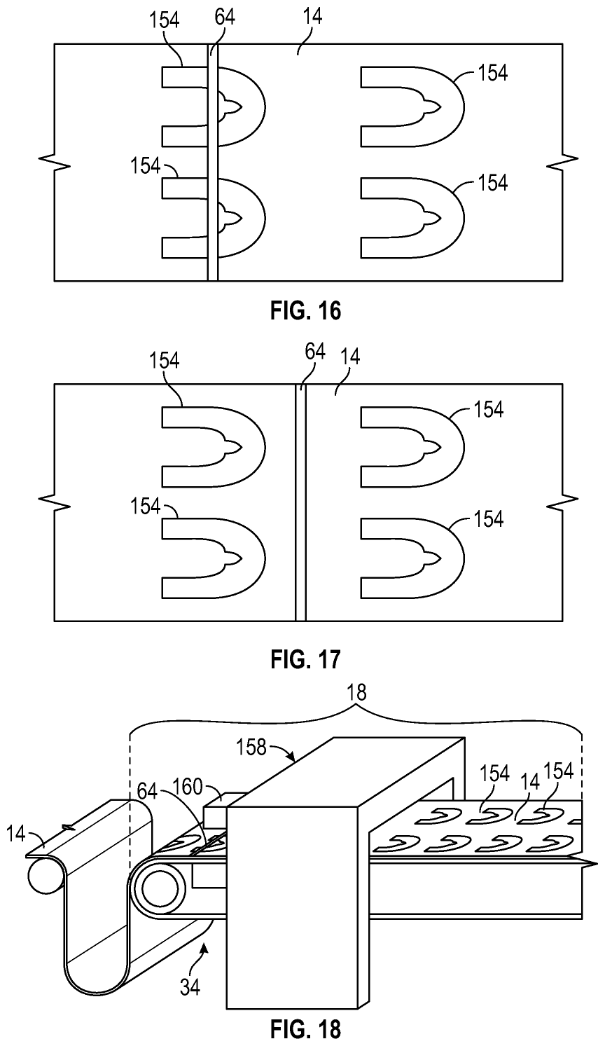

FIGS. 16 and 17 illustrates portion of a substrate with upper patterns 154 printed thereon by print station 16. In the example shown in FIG. 16, the printed material was printed onto the substrate 14 as it was received at the print station 16. As a result, the pattern extends over a portion of the substrate that is unsuitable for use because of the presence of the connecting member 64. In contrast, FIG. 17 illustrates shows an example where a sensor 156 identified the presence of connecting member 64 and print station 16 stopped printing and restarted printing the desired pattern after the portion of the substrate 14 having connecting member 64 passed.

Sensor 156 can also be used to identify any other areas of the substrate that may make printing undesirable, such as tears, holes, or other imperfections in the material of the substrate. As with the detection of the presence of a coupling member, the system can adjust printing accordingly to avoid these identified undesirable areas.

### EXAMPLE 1

An exemplary arrangement of headbox 30 is provided below. In this example, headbox 30 has six rows of print assemblies. Table 1 below describes the print materials and related nozzle head types that can be used in this example.

TABLE 1

| Print Assembly | Ink | Function (# printheads) | Head Type |
|---|---|---|---|
| First | White | White layer 1 (2) | SA - 16 pl |
| Second | White | White layer 2 (2) | SA - 16 pl |
| Third | Color | Color layer (8) | SA/2C - 16 pl |
| Fourth | Varnish | Matte/Gloss Protection Large Texture (2) | MA - 42 pl |
| Fifth | Varnish | Matte/Gloss Protection Small Texture (2) | SA - 16 pl |
| Sixth | Varnish | Matte/Gloss Protection Low Tack (2) | SA - 16 pl |

Referring to FIGS. 11A-11F and 12A-12F, a series of layers are formed on a substrate. The first layer 102a is formed by depositing a first print material of white ink. The first layer 102a is formed from two layers of dispensed ink from printheads 120, 122. The first layer is cured and acts as a primer providing about 50% opacity. The second layer 104a is formed from two layers of dispensed ink from printheads 124, 126. The second layer is cured, providing about 100% opacity. The third layer 106a is formed from multiple layers of dispensed color ink from printheads 128, 130, 132, 134, 136, 138, 140, 142. The third layer is cured.

The fourth layer 108a is formed from two layers of dispensed vanish from printheads 144, which is then cured. The fifth layer 110a is also formed from two layers of dispensed varnish from print heads 146, but a smaller nozzle head is used for dispensing the fifth layer. The fifth layer is not cured. The sixth layer 112a is dispensed from print heads 148 and mixes, at least partially with the uncured fifth layer. The sixth layer 112a can then be cured. If desired, the curing assembly of the sixth member can be moved in the direction of the longitudinal axis to delay curing (e.g., as shown in FIG. 14), which can increase the glossiness of the resulting layer.

As discussed above, each of the first, second, third, fourth, fifth, and sixth layers can be formed from more than one layer. For example, the eight printheads of the third print assembly can be used to provide eight layers that collectively form the third layer 106a.

Thus, in some embodiments, some of the rows of print assemblies can dispense print materials for forming one or more base layers on the substrate 14 (e.g., a primer layer, such as one or more white layers), one or more color or structural layers of print material formed on the one or more base layers, and one or more finishing layers (e.g., one or more protective layers, such as one or more varnish layers). In should be understood, however, that the selection of layers and their order can vary. For example, one or more of these layers can be omitted, the order rearranged (e.g., a structural or color layer can be the first layer formed on the substrate), and/or additional layers provided.

Headbox 30 can also comprise more or fewer than the six rows described above with respect to Example 1. The number and types of print assemblies in each row can also vary. Examples 2 and 3 illustrate other possible exemplary arrangements.

### EXAMPLE 2

Another exemplary arrangement of headbox 30 is provided below. In this embodiment, four rows of print assemblies are provided as shown in Table 2 below.

TABLE 1

| Print Assembly | Ink | Function (# printheads) | Head Type |
|---|---|---|---|
| First | White | White layer 1 (4) | SA - 16 pl |
| Second | Color | Color layer (8) | SA /2C - 16 pl |
| Third | Color | Color layer (8) | SA /2C - 16 pl |
| Fourth | Varnish | Matte/Gloss Protection Small Texture (4) | SA - 16 pl |

### EXAMPLE 3

Another exemplary arrangement of headbox 30 is provided below. In this embodiment, eight rows of print assemblies are provided as shown in Table 3 below.

TABLE 3

| Print Assembly | Ink | Function (# printheads) | Head Type |
|---|---|---|---|
| First | White | White layer 1 (4) | SA - 16 pl |
| Second | White | White layer 2 (4) | SA - 16 pl |
| Third | Clear | Structural layer 1 (4) | SA/2C - 16 pl |
| Fourth | Color | Color layer (8) | SA/2C - 16 pl |
| Fifth | Color | Color layer (6) | SA/2C - 16 pl |
| Fourth | Varnish | Matte/Gloss Protection Large Texture (6) | MA - 42 pl |
| Fifth | Varnish | Matte/Gloss Protection Small Texture (2) | SA - 16 pl |
| Sixth | Varnish | Matte/Gloss Protection Low Tack (2) | SA - 16 pl |

The dispensing of print materials in Examples 2 and 3 can be like that described in Example 1 and elsewhere herein.

Exemplary Cutting Systems and Methods

FIG. 18 illustrates cutting station 18, which is positioned downstream of print station 16 and can cut and/or remove portions of the material as it is received on a second conveyor system 34. Cutting station 18 can have one or more different cutting systems 158 as needed to cut out portions of the substrate (such as the upper patterns 154 shown in FIG. 15). For example, cutting system(s) 158 can comprise a digital cutter that uses a laser-based cutting system. Alternatively, the substrate may be cut by any other means one or more cutting means, such as a knife, a die, a punch, and/or a hot edge. The cut can be to remove the pattern from the substrate by cutting, for example, along a perimeter of the upper pattern. Alternatively, the cutting system can remove or cut some portion within the upper pattern, thereby forming an aperture or the like.

In some embodiments, a sensor 160 can be provided to identify the location of connecting members 64. Sensor 160 can be the same type of sensor as described above with respect to sensor 156. Sensor 160 can be provided in addition to or as an alternative to sensor 156. Like sensor 156, sensor 160 can inform cutting system 158 of the location of connecting members 64 and the system can adjust cutting accordingly, such as by not cutting upper patterns that include at least a portion of a connecting member 64.

Printing Controls

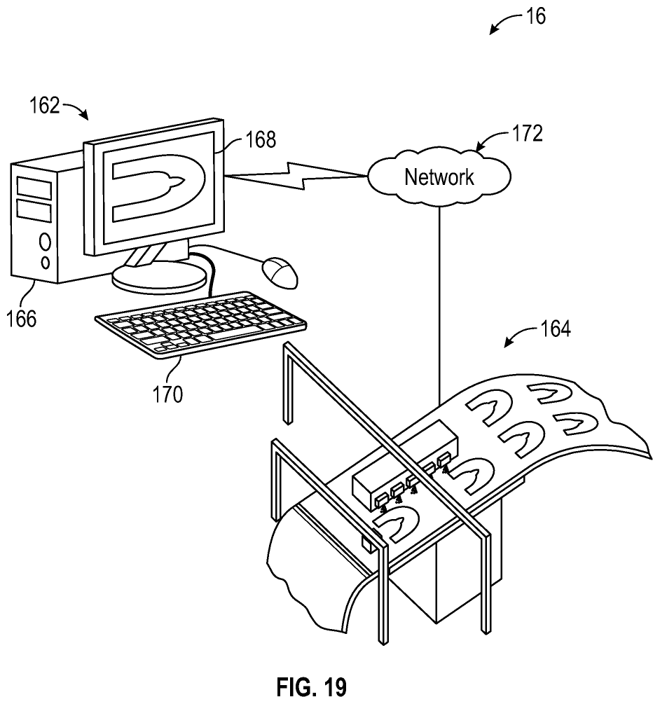

FIG. 19 illustrates an exemplary embodiment of the control of print station 16 by a computing system 162.

In some embodiments, print station 16 can include provisions that control and/or receive information from the headbox and associated printing/curing assemblies (collectively referred to as printing device 164). These provisions can include a computing system 162 and a network 172. Generally, the term “computing system” refers to the computing resources of a single computer, a portion of the computing resources of a single computer, and/or two or more computers in communication with one another. Any of these resources can be operated by one or more human users. In some embodiments, computing system 162 may include one or more servers. In some embodiments, a print server may be primarily responsible for controlling and/or communicating with printing device 164, while a separate computer (e.g., desktop, laptop or tablet) may facilitate interactions with a user. Computing system 162 can also include one or more storage devices including, but not limited to, magnetic, optical, magneto-optical, and/or memory, including volatile memory and non-volatile memory.

In those instances where a computing system is used, any suitable hardware or hardware systems may be used to facilitate provisions that control and/or receive information from printing device 164. In some embodiments, where a computing system is used, computing system 162 may include a central processing device 166, a viewing interface 168 (e.g., a monitor or screen), input devices 170 (e.g., keyboard and mouse), and software for designing a computer-aided design representation of a printed structure. However, in other embodiments, other forms of hardware systems may be used.

In those instances where software for designing a computer-aided design representation of a print material pattern on a substrate is used, any suitable information may be used to facilitate provisions for designing a computer-aided design representation of a pattern of print material. In at least some embodiments, the computer-aided design representation of a printed layer and/or printed structure on the substrate may include not only information about the geometry of the structure, but also information related to the materials required to print various portions of the structure. However, in other embodiments, different information may be used.

In those instances where software for designing a computer-aided design representation of a printed structure is used, any suitable design structure may be used to transform the design into information that can be interpreted by printing device 164 (or a related print server in communication with printing device 164).

In some embodiments, print station 16 may be operated as follows to provide one or more structures or patterns of print material on a substrate using a three-dimensional printing, or additive process. Computing system 162 may be used to design a pattern or structure for printing onto a substrate. This may be accomplished using some type of CAD software, or other kind of software. The design may then be transformed into information that can be interpreted by printing device 164 (or a related print server in communication with printing device 164). In some embodiments, the design may be converted to a three-dimensional printable file, such as a stereolithography file (STL file); in other cases, the design may be converted into a different design structure. In still other embodiments, information about a structure to be printed may be sent in the form of an image file in which case image information (colors, hues, shades, transparency, etc.) of different regions can be used to determine a corresponding 3D structure.

In those instances where a network is used, network 172 may use any wired or wireless provisions that facilitate the exchange of information between computing system 162 and printing device 164. In some embodiments, network 172 may further include various components such as network interface controllers; repeaters, hubs, bridges, switches, routers, modems, and firewalls. In some embodiments, network 172 may be a wireless network that facilitates wireless communication between two or more systems, devices, and/or components of print station 16. Examples of wireless networks include, but are not limited to, wireless personal area networks (including, for example, Bluetooth), wireless local area networks (including networks utilizing the IEEE 802.11 WLAN standards), wireless mesh networks, mobile device networks as well as other kinds of wireless networks. In other cases, network 172 could be a wired network including networks whose signals are facilitated by twister pair wires, coaxial cables, and optical fibers. In still other cases, a combination of wired and wireless networks and/or connections could be used.

As discussed, a printing system may distribute various functionality across one or more devices or systems. In those instances where the printing system includes provisions that distribute one or more functions among different devices of print station 16, any suitable protocol, format, and method may be used to facilitate communication among the devices of print station 16. In some embodiments, these communications are conducted using the network 172, in other cases, these communications may be conducted directly between devices of print station 16.

Computing system 162 may control print station 16 and its operation, as well as the operation of the roll dispensing and conveying systems. For example, computing system 162 can receive information about a required and/or desired roll change at roll station 12 (e.g., either based on an amount of dispensing material remaining in the active roll or at the request of a user) and instruct the system to create a specific amount of slack in the substrate by controlling the movement of tensioning roller 42 in a predetermined manner to create slack as described herein. Computing system 162 can also control the speed by which the substrate is conveyed in the system. Thus, for example, the computing system can instruct the drive rollers of the conveyor systems to stop to allow a printing operation to occur, and, based on a pattern or structure received by the computing system, instruct the headbox to move laterally and dispense print materials from one or more of the print assemblies and control the operation of the curing assemblies. When a print operation is completed, the computing system can instruct the advancement of the substrate to perform a next print operation with the substrate at a different, longitudinal position relative to the headbox.

Computing system 162 can also be configured to control the sensors discussed herein. Thus, for example, upon receiving an indication from the collision sensor that the substrate has exceeded a desired height, computing system 162 can instruct the system to stop the operation of the printing process, adjust the position of the substrate 14 on belt 88, and/or adjust the relative spacing between the surface of the material and the print/curing assemblies (e.g., by lowering the height of the first conveyor system with the position control members 86).

Similarly, computing system 162 can receive information from one or more sensors that, as described here, detect the presence and location of a connecting member 64 (e.g., tape coupling a first roll to a second roll). Upon receiving an indication from the sensor that a connecting member 64 was detected, the computing system can instruct the system to adjust the process accordingly, such as by halting or changing a printing operation at the print station and/or adjusting a cutting operation at the cutting station as discussed herein.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims.

I therefore claim as my invention all that comes within the scope and spirit of these claims:

1. A printing system for printing on a substrate, comprising:
a conveyor system for conveying a substrate along a longitudinal axis of the conveyor system;
a headbox supported over at least a portion of the conveyor system, the headbox having a plurality of print assemblies sequentially arranged in rows along the longitudinal axis, the plurality of print assemblies including at least a first print assembly, a second print assembly, a third print assembly, and a fourth print assembly;
an actuating system configured to move the headbox laterally across the substrate on the conveyor system;
the first print assembly being located within a first row of the headbox and having a plurality of first printheads;
the second print assembly being located within a second row of the headbox and having a plurality of second printheads;
a third print assembly being located within a third row of the headbox and having a plurality of third printheads; and
a fourth print assembly being located within a fourth row of the headbox and having a plurality of fourth printheads,
wherein the first print assembly, the second print assembly, the third print assembly, and the fourth print assembly are configured to independently dispense print materials onto the substrate.

2. The printing system of claim 1, wherein the first print assembly, the second print assembly, the third print assembly, and the fourth print assembly each has between two and eight printheads.

3. The printing system of claim 1, wherein the positions of the first printheads, second printheads, third printheads, and fourth printheads are fixed within their respective rows.

4. The printing system of claim 1, wherein the first printheads, second printheads, third printheads, and fourth printheads are moveable within their respective rows.

5. The printing system of claim 1, the plurality of print assemblies further including a fifth print assembly, the fifth print assembly being located within a fifth row of the headbox and having a plurality of fifth printheads.

6. The printing system of claim 5, the plurality of print assemblies further including a sixth print assembly, the sixth print assembly being located within a sixth row of the headbox and having a plurality of sixth printheads.

7. The printing system of claim 1, wherein at least one of the first, second, third, and fourth printheads dispenses a different print material than at least another of the first, second third, and fourth printheads.

8. The printing system of claim 1, further comprising a plurality of curing assemblies, wherein at least one curing assembly is provided in the first, second, third, and fourth rows of the headbox.

9. The printing system of claim 1, further comprising a plurality of curing assemblies, wherein two curing assemblies are provided in the first, second, third, and fourth rows of the headbox, the curing assemblies being positioned on opposing sides of the plurality of printheads in each row.

10. The printing system of claim 1, further comprising a plasma cleaning station positioned upstream from the conveyor system and downstream from a first spindle-supporting arm of a roll dispensing system of a substrate to be printed upon.

11. The printing system of claim 1, further comprising at least one collision sensor that is configured to detect a decrease in an amount of spacing between a surface of the substrate and the headbox and/or the plurality of print assemblies as the substrate moves along the conveyor system.

12. The printing system of claim 1, wherein the conveyor system is a vacuum conveyor system that comprises a perforated belt and a vacuum system disposed below at least a portion of the headbox.

13. The printing system of claim 1, wherein the conveyor system comprises at least one guide member on one or both sides of the conveyor system, the at least one guide member being sized to receive a lateral edge of the substrate as it is conveyed on the conveyor system, a portion of the guide system configured to receive the lateral edge of the substrate being positioned below a highest point of a belt of the conveyor system.

14. A method of printing on a substrate being conveyed along a longitudinal axis of a conveyor system, comprising:
positioning a headbox over the substrate, the headbox comprising a plurality of print assemblies arranged sequentially in rows along the longitudinal axis, the plurality of rows of print assemblies including at least a first print assembly, a second print assembly, a third print assembly, and fourth print assembly, wherein each of the first, second, third, and fourth print assemblies has a plurality of printheads;
performing a first printing operation comprising:
dispensing first print materials from one or more of the plurality of printheads of the first print assembly on a first portion of the substrate to form a first layer;
dispensing second print materials from one or more of the plurality of printheads of the second print assembly on a second portion of the substrate to form a second layer, the second portion having already received the first layer of print materials;
dispensing third print materials from one or more of the plurality of printheads of the third print assembly on a third portion of the substrate, the third portion having already received the first layer of first print materials and the second layer of second print materials; and
dispensing fourth print materials from one or more of the plurality of printheads of the fourth print assembly on a fourth portion of the substrate, the fourth portion having already received the first layer of first print materials, the second layer of second print materials, and the third layer of third print materials;
advancing the position of the substrate on the conveyor system along the longitudinal axis; and
performing a second printing operation comprising:
dispensing first print materials from one or more of the plurality of printheads of the first print assembly on a subsequent portion of the substrate to form a first layer;
dispensing second print materials from one or more of the plurality of printheads of the second print assembly on the first portion of the substrate to form a second layer, the first portion having already received the first layer of print materials;
dispensing third print materials from one or more of the plurality of printheads of the third print assembly on the second portion of the substrate, the second portion having already received the first layer of first print materials and the second layer of second print materials; and
dispensing fourth print materials from one or more of the plurality of printheads of the fourth print assembly on the third portion of the substrate, the third portion having already received the first layer of first print materials, the second layer of second print materials, and the third layer of third print materials,
wherein the headbox moves laterally across the substrate as it dispenses the first, second, third, and fourth print materials.

15. The method of claim 14, wherein the sequentially arranged rows of the plurality of print assemblies includes a fifth print assembly that has a plurality printheads,
the first printing operation further comprising:
dispensing fifth print materials from one or more of the plurality of printheads of the fifth print assembly on a fifth portion of the substrate, the fifth portion having already received the first layer of first print materials, the second layer of second print materials, the third layer of third print materials, and the fourth layer of fourth print materials; and
the second printing operation further comprising:
dispensing fifth print materials from one or more of the plurality of printheads of the fifth print assembly on the fourth portion of the substrate, the fourth portion having already received the first layer of first print materials, the second layer of second print materials, the third layer of third print materials, and the fourth layer of print materials.

16. The method of claim 15, wherein the sequentially arranged rows of the plurality of print assemblies includes a sixth print assembly that has a plurality printheads,
the first printing operation further comprising:
dispensing sixth print materials from one or more of the plurality of printheads of the sixth print assembly on a sixth portion of the substrate, the sixth portion having already received the first layer of first print materials, the second layer of second print materials, the third layer of third print materials, the fourth layer of fourth print materials, and the fifth layer of print materials; and
the second printing operation further comprising:
dispensing sixth print materials from one or more of the plurality of printheads of the sixth print assembly on the fifth portion of the substrate, the fifth portion having already received the first layer of first print materials, the second layer of second print materials, the third layer of third print materials, the fourth layer of print materials, and the fifth layer of print materials.

17. The method of claim 14, comprising:
the first printing operation further comprising:
curing one or more of the first, second, third, and fourth layers with one or more curing assemblies of the headbox; and
the second printing operation further comprising:
curing one or more of the first, second, third, and fourth layers with one or more curing assemblies of the headbox.

18. The method of claim 17, wherein the headbox includes a first curing assembly adjacent to the first print assembly, a second curing assembly adjacent to the second print assembly, a third curing assembly adjacent to the third print assembly, and a fourth curing assembly adjacent to the third print assembly.

19. The method of claim 18, wherein the first, second, third, and fourth curing assemblies are independently operable.

20. The method of claim 17, wherein one or more of the first, second, third, and fourth curing assemblies are moveable relative to the respective first, second, third, and fourth print assemblies, and the curing of one or more of the first, second, third, and fourth layers comprises:
adjusting a position of at least one of the first, second, third, and fourth curing assemblies to adjust a timing between the dispensing of the first, second, third, or fourth print materials and the curing of a respective one of the first, second, third, or fourth layer.

21-40. (canceled)
